(19) United States
(12) Patent Application Publication
(10) Pub. No.: US 2024/0077641 A1
(43) Pub. Date: Mar. 7, 2024

(54) DERIVED BULK DENSITY WHILE DRILLING FROM AZIMUTHAL GAMMA RAY AT BIT

(71) Applicant: Saudi Arabian Oil Company, Dhahran (SA)

(72) Inventor: Mohamed Amine Haceb, Dhahran (SA)

(21) Appl. No.: 17/903,741

(22) Filed: Sep. 6, 2022

(51) Int. Cl. G01V 11/00; E21B 49/00

(52) U.S. Cl. CPC G01V 11/002; E21B 49/00

(57) ABSTRACT

The present disclosure provides a method computer-implemented method for conducting a measurement while drilling (MWD) operation in a wellbore of a reservoir, the method comprising: accessing data encoding measurements obtained from a bit tool during the MWD operation in the wellbore of the reservoir, wherein the bit tool includes a gamma ray detector and a magnetometer; extracting, from the measurements, recordings of a gamma ray detector, wherein the recordings comprise gamma ray measurements taken from more than one azimuthal sectors of a depth location in the wellbore; estimating a bulk density at the depth location in the wellbore using the gamma ray measurements from the more than one azimuthal sectors; and based on, at least in part, the estimated bulk density, adjusting the MWD operation.

### TECHNICAL FIELD

This disclosure generally relates to performing measurement while drilling (MWD) operations at a wellbore of an oil and gas reservoir.

### BACKGROUND

During a drilling operation at an oil and gas reservoir, density of medium can be measured by analyzing logs extracted from the well at various depths. However, well log samples may not always be available, for example, at all intervals.

### SUMMARY

In one aspect, implementations provide a computer-implemented method for conducting a measurement while drilling (MWD) operation in a wellbore of a reservoir, the method comprising: accessing data encoding measurements obtained from a bit tool during the MWD operation in the wellbore of the reservoir, wherein the bit tool includes a gamma ray detector and a magnetometer; extracting, from the measurements, recordings of the gamma ray detector, wherein the recordings comprise gamma ray measurements taken from more than one azimuthal sectors of a depth location in the wellbore; estimating a bulk density at the depth location in the wellbore using the gamma ray measurements from the more than one azimuthal sectors; and based on, at least in part, the estimated bulk density, causing an adjustment of the MWD operation.

Implementations may include one or more of the following features.

The computer-implemented method may further include: extracting, from the measurements, recordings of the magnetometer; and dividing the recordings of the gamma ray detectors into the more than one azimuthal sectors based on sensed directional data from magnetometer. The computer-implemented method may further include: based on the estimated bulk density, synthesizing a bulk density log over a range of depth locations. The computer-implemented method may further include: obtaining an estimated total porosity using the estimated bulk density at the depth location. The computer-implemented method may further include: obtaining an estimated share of gas and shale at the depth location based on pulsed neutron measurements. The computer-implemented method may further include: obtaining an estimated effective porosity that removes the estimated share of gas and shale from the estimated total porosity. The computer-implemented method may further include: calibrating the estimated bulk density again bulk density measured at a core sample extracted from the wellbore at the depth location.

In another aspect, implementations provide a computer system for conducting a measurement while drilling (MWD) operation in a wellbore of a reservoir, the computer system comprising one or more computer processors configured to perform operations of: accessing data encoding measurements obtained from a bit tool during the MWD operation in the wellbore of the reservoir, wherein the bit tool includes a gamma ray detector and a magnetometer; extracting, from the measurements, recordings of a gamma ray detector, wherein the recordings comprise gamma ray measurements taken from more than one azimuthal sectors of a depth location in the wellbore; estimating a bulk density at the depth location in the wellbore using the gamma ray measurements from the more than one azimuthal sectors; and based on, at least in part, the estimated bulk density, causing an adjustment of the MWD operation.

Implementations may include one or more of the following features.

The operations may further include: extracting, from the measurements, recordings of the magnetometer; and dividing the recordings of the gamma ray detectors into the more than one azimuthal sectors based on sensed directional data from magnetometer. The operations may further include: based on the estimated bulk density, synthesizing a bulk density log over a range of depth locations. The operations may further include: obtaining an estimated total porosity using the estimated bulk density at the depth location. The operations may further include: obtaining an estimated share of gas and shale at the depth location based on pulsed neutron measurements. The operations may further include: obtaining an estimated effective porosity that removes the estimated share of gas and shale from the estimated total porosity. The operations may further include: calibrating the estimated bulk density again bulk density measured at a core sample extracted from the wellbore at the depth location.

In yet another aspect, implementations provide a non-transitory computer-readable medium comprising software instructions for conducting a measurement while drilling (MWD) operation in a wellbore of a reservoir, which software instructions, when executed by a computer processor, cause the computer processor to perform operations of: accessing data encoding measurements obtained from a bit tool during the MWD operation in the wellbore of the reservoir, wherein the bit tool includes a gamma ray detector and a magnetometer; extracting, from the measurements, recordings of a gamma ray detector, wherein the recordings comprise gamma ray measurements taken from more than one azimuthal sectors of a depth location in the wellbore; estimating a bulk density at the depth location in the wellbore using the gamma ray measurements from the more than one azimuthal sectors; and based on, at least in part, the estimated bulk density, causing an adjustment of the MWD operation.

Implementations may include one or more of the following features.

The operations may further include: extracting, from the measurements, recordings of the magnetometer; and dividing the recordings of the gamma ray detectors into the more than one azimuthal sectors based on sensed directional data from magnetometer. The operations may further include: based on the estimated bulk density, synthesizing a bulk density log over a range of depth locations. The operations may further include: obtaining an estimated total porosity using the estimated bulk density at the depth location. The operations may further include: obtaining an estimated share of gas and shale at the depth location based on pulsed neutron measurements. The operations may further include: obtaining an estimated effective porosity that removes the estimated share of gas and shale from the estimated total porosity. The operations may further include: calibrating the estimated bulk density again bulk density measured at a core sample extracted from the wellbore at the depth location.

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIG. 1 shows a diagram of a tool bit with a gamma ray detector for azimuthal measurements according to some implementations of the present disclosure.

FIG. 2 shows an example of a chart comparing the measured bulk density and the synthetic bulk density according to some implementations of the present disclosure.

FIG. 3 shows an example of a histogram of synthesized bulk density and measured bulk density according to some implementations of the present disclosure.

FIG. 4 shows an example of a cross plot of the predicted/synthesized bulk density and the measured bulk density according to some implementations of the present disclosure.

FIG. 5. shows another example of a cross plot of the predicted bulk density and neutron porosity according to some implementations of the present disclosure.

FIG. 6 shows an example of a table tabulating the calculated porosity using synthetic density log according to some implementations of the present disclosure.

FIG. 7 shows an example of a cross plot of measured bulk density and the gamma ray ratio according to some implementations of the present disclosure.

FIG. 8 shows an example of a cross plot of the synthetic bulk density and gamma ray ratio according to some implementations of the present disclosure.

FIG. 9 shows an example of a cross plot of synthetic bulk density and measured bulk density according to some implementations of the present disclosure.

FIG. 10 shows an example of a histogram of synthetic bulk density obtained from five wells according to some implementations of the present disclosure.

FIG. 11 shows an example of a cross plot of synthetic bulk density and measured bulk density for this group of five wells according to some implementations of the present disclosure.

FIGS. 12A and 12B show examples of comparing the measured bulk density and the synthetic bulk density according to some implementations of the present disclosure.

FIG. 13 shows an example of a chart comparing synthetic bulk density and measured density in a sixth wellbore according to some implementations of the present disclosure.

FIG. 14 shows an example of a cross plot comparing measured bulk density and derived density in the sixth wellbore according to some implementations of the present disclosure.

FIG. 15 shows an example of cross plot comparing synthetic bulk density and measured neutron porosity according to some implementations of the present disclosure.

FIG. 16 shows chart demonstrating a significant agreement between the two calculated porosities (total and effective) across an open hole logged interval.

FIG. 17 shows an example of a cross plot comparing synthetic bulk density and neutron porosity for shale classification according to some implementations of the present disclosure.

FIG. 18 shows another example of a cross plot comparing synthetic bulk density and gamma ray measurements according to some implementations of the present disclosure.

FIG. 19 shows an example of a flow chart according to an implementation of the present disclosure.

FIG. 20 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

When drilling at an oil and gas reservoir, core samples may not be available at every depth interval. For this reason alone, synthetic log is often created, where core samples are not available, by using an empirical relationship across a specific depth interval. However, the calculated log has a limitation to provide a reasonable value over the interval where the log is edited due to lithology changes.

The disclosed technology is directed to systems and methods that operate by obtaining azimuthal gamma ray measurements (e.g., Geiger counter readout) from natural radiation and then deriving a density estimate based on the azimuthal gamma ray measurements without referring to neural network or regression approaches. In some implementations, the derivation applies a developed formula based on a ratio of, for example, upper and lower azimuthal quadrants relative to an axial direction of the bit tool. Using cross plot and multiple regression, the implementations may verify the accuracy of the derived log and highlight the zones with less discrepancy. Some implementations can use the derived log with the computed density curve to estimate the porosity of the reservoir medium at the corresponding depth and then combine the computed density curve with neutron log for shale classification across the logged interval. In some implementations, the computed density porosity has been compared to measured log along two lateral section drilled in different depositional environment carbonate source rock and siliciclastic reservoir. The results demonstrate excellent capability of the implementations to handle lithology variation. In other words, the implementations can be used in measurement while drilling (MWD) and logging while drilling (LWD) operations to assist geosteering and well placement, reservoir characterization and geomechanics (rock mechanical properties), as well as drilling to estimate pore pressure and identify subsurface over-pressurized zone.

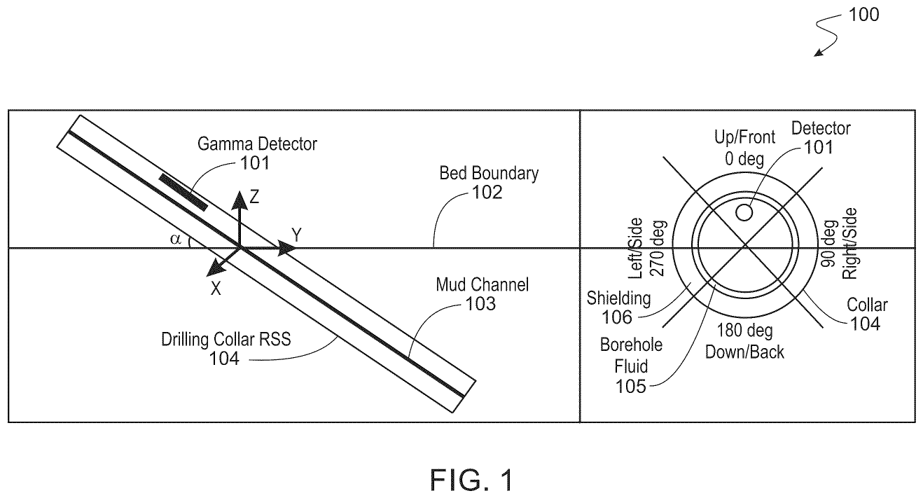

Referring to FIG. 1 illustrating diagram 100, various implementations can incorporate an azimuthal gamma ray detector 100. For example, a bit tool can include a rotary steerable system (RSS) collar 104 with shielding 106 arranged as an annulus that encloses mud channel 104 and gamma detector 100. In some cases, the bit tool can be 6¾ in outer diameter and deployed to drill a borehole with a 8½ in inner diameter. Borehole fluid 105 can also be present inside collar 104. In this configuration, gamma detector 100 can detect azimuthally natural radioactivity of the formation surrounding the borehole. For example, gamma detector 100 can be a passive gamma ray collector device ranging from a Geiger counter to more sophisticated solid-state scintillation crystals such as NaI capable of producing a flash of light upon absorbing a gamma ray, which can trigger a photomultiplier to generate an electrical pulse. During a drilling operation, gamma ray detector 100 may rotate with the bit tool, and magnetometers and accelerometers can provide azimuthally detector position. For example, the azimuthal direction may be relative to an axial direction of the bit tool. The total gamma ray count rate can be obtained for each position accordingly under each relative dip angle. The bit tool may additionally include a neutron source and neutron counters for pulsed neutron measurement during drilling.

As illustrated, the cross-section profile of the bit tool has four quadrants, namely, the up/front quadrant facing the 0 degree direction, the right side quadrant facing the 90 degree direction, the down/back quadrant facing the 180 degree direction, and the left side quadrant facing the 270 degree direction. In some implementations, the bit tool has a scribe line on the high side (e.g., the 0 degree direction) to determine the North. Gamma detector 100 can be placed in this up/front quadrant, as illustrated in FIG. 1. A magnetometer within the bit tool can sense the Earth's magnetic field relative to the tool face while the bit tool rotates during a drilling operation. The sensed directional data can enable the counted rate from gamma detector 100 to be divided into sectors based on the four illustrated quadrants. The sectors or quadrants are oriented relative to the tool face using survey (azimuth and inclination) based on the directional data. The count rate in each sector or quadrant can be binned over a defined acquisition time to obtain values in counts per second then converted to American Petroleum Institute (API) units. For example, if eight (8) sectors are presented for Azimuthal gamma image, then the four quadrants can be provided as the following: Up (7+0), Down (3+4), Left (5+6), Right (1+2), as illustrated in FIG. 1. In some cases, measurements taken at the upper and lower gamma ray quadrants at the tool bit are instantly transmitted in real time to surface, while other measurements data are stored in the memory. The real-time data of upper and lower gamma ray have been used quantitatively in geosteering as well as in predicting the bulk density log.

During operation of gamma detector 100, the time of exposure may determined based on telemetry, rate of penetration (ROP), and sampling rate (measured in terms of depth intervals). In some cases, a period of 10 seconds can be used. However, when the bottom hole assembly (BHA) contain additional logging while drilling (LWD) tools, the exposure time may be increased and the sampling rate can be decreased to, for example, 0.25 ft, to maintain quality data with no gaps.

In some implementations, the azimuthal bulk density can be determined in 16 sectors or 4 quadrants, e.g., the Up, Down, Left and Right quadrants as shown in FIG. 1. The formation bulk density can be calculated as the average of the four quadrants or the average of the 16 bins, the latter of which can be the better fit bulk density. These determined bulk density can be used in various implementations as quality control to validate the synthetic curve. Various implementations described in the present disclosure may assume the bit tool is centered in the borehole with no further effect on the gamma ray attenuation from borehole conditions, mud weight or tool size.

The implementations described in the present disclosure can derive or synthesize density log while drilling and honoring rock matrix variation and data quality. By way of contextual explanation, total natural gamma radioactivity, which gives rise to readings on gamma detector 100, generally depends on the content of uranium, thorium and potassium in the formation. Gamma detector 100 can include a scintillator configuration mounted in the drilling collar 104 and can record azimuthally the gamma ray readout while drilling, as depicted in diagram 100 of FIG. 1.

The implementations may operate by leveraging the Beer-Lambert gamma ray attenuation law (1) as the gamma rays counts rate has an exponential inverse proportion in relation to the density.

N=N₀exp(−μρx) (1),

where N is the attenuated gamma radiation count (API), N₀ is the incident gamma radiation (API), μ is the masse adsorption coefficient (g/cm2), ρ is bulk density (g/cc), x is thickness of material (cm).

In various implementations, the distance between radioactive source and detector x can be replaced by 2πr/4 in the absence of radioactive source or back scattering phenomena. Inserting the two quadrant gamma ray measurements, namely, GRT for the Up quadrant, and GRB for the down quadrant, in the above equation (1) and assuming the masse coefficient of the absorber is equal to 1 for a complex material (e.g., drilling fluid and collar body), the exponential count ratio can determine the bulk density as follows:

−ln(N/N₀)=μρx (2),

where x=2πr/4 and r=d/2 (d: tool diameter).

By isolating density:

−ln(N/N₀)/μx+c=ρ (3),

where C is a constant parameter determined empirically and adjusted accordingly to match the expected or measured density over a specific depth interval.

By replacing N, N₀ with the two quadrant gamma ray measurements, namely, GRT for the Up quadrant, and GRB for the down quadrant, the following can be obtained:

ρ=−ln(GRT/GRB)/x+c (4).

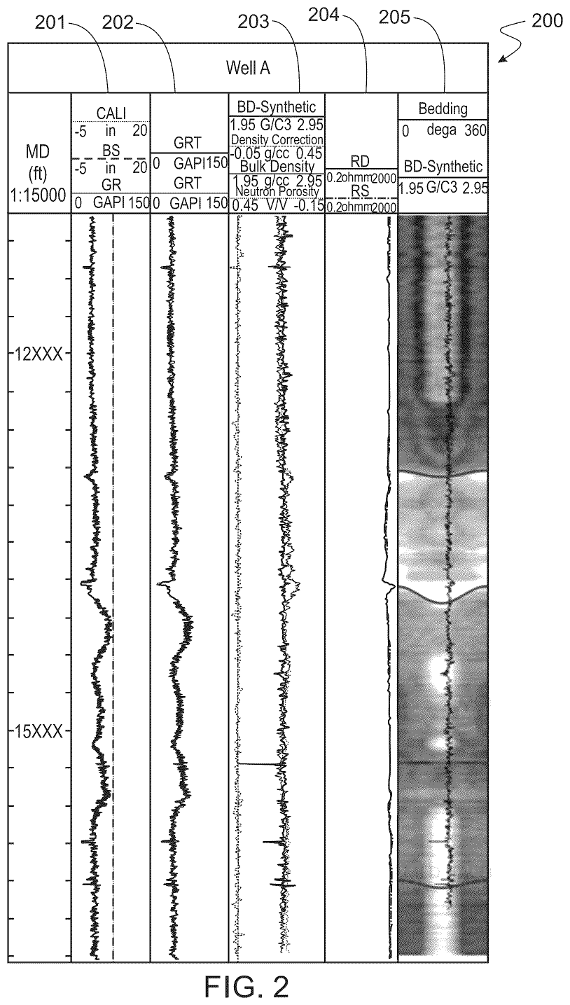

In the above context, FIG. 2 shows a chart 200 comparing the measured bulk density (actual) and the synthetic bulk density (derived) for a first wellbore. Track 201 shows the average gamma ray measurements from the Up and Down quadrants as a function of depth. Track 202 shows the gamma ray measurements from the Up and Down quadrants (GRT and GRB) as a function of depth. Track 203 shows synthetic bulk density (BD) calculated based on equation 4, measured bulk density, and measured neutron porosity, as functions over the same depth range as tracks 201 and 202. Track 204 shows resistivity as a function over the same depth range. For reservoir characterization, triple combo logging while drilling (LWD) including gamma ray, density neutron porosity, and induction resistivity for hydrocarbon saturation are customarily utilized. Track 205 shows a pixelated display of synthetic bulk density over the same depth range. In particular, the delivered four quadrants azimuthal density image log were acquired across the horizontal section from measured 16 sectors or bins formation density. The 360-degree span was divided into 16 sectors. Each sector has a 22.5-degree angle in the image log in which the quadrants will be arranged in the following order: U (16.3), R (4,7), D (8,11), and L (12,15). The quality of the image log is based on the vertical resolution of the tool. A good match covering the entire depth interval has been obtained, with an average density of 2.53 g/cc, which is acceptable value for the underlying carbonate reservoir source rock when the measured bulk density curve is the average of the four quadrant azimuthal density data.

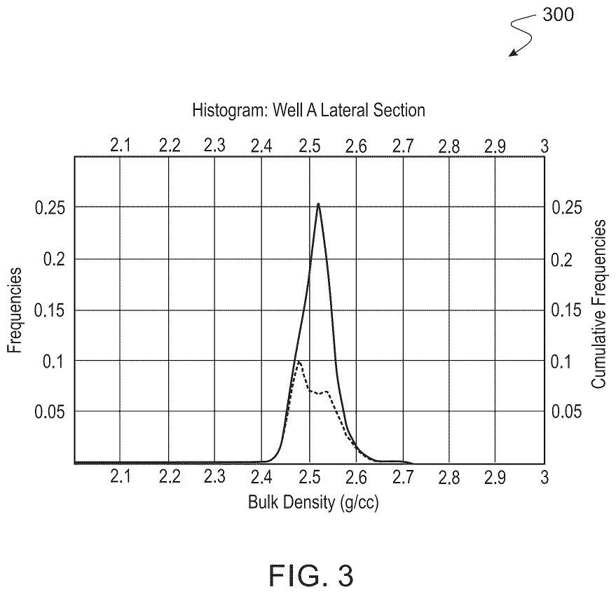

FIG. 3 shows a histogram 300 of predicted/synthesized (dashed) bulk density and measured bulk density (solid), demonstrating a general coincidence of recorded data values from this first wellbore.

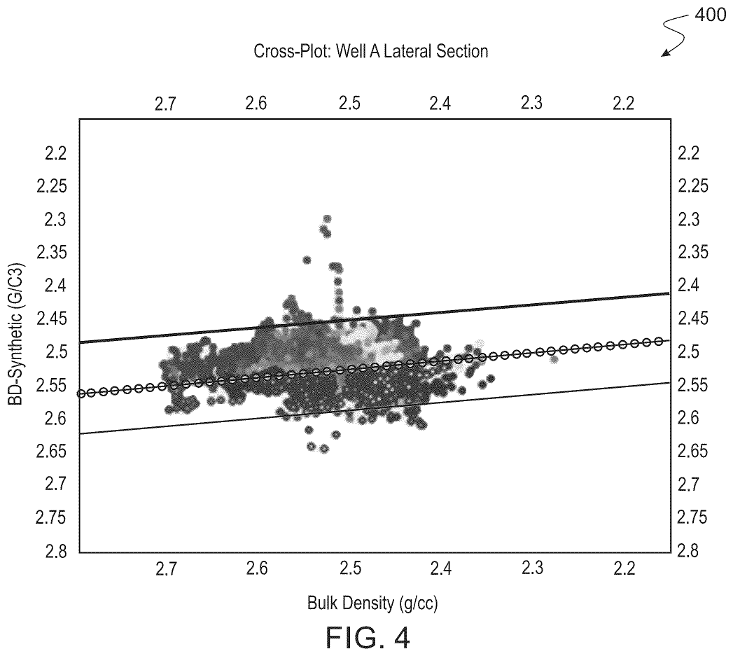

FIG. 4 shows cross plot 400 of the predicted/synthesized bulk density and the measured bulk density from this first wellbore. On this cross plot 400, the middle dotted line distinguishes data from dense layers (represented by dark dots below the middle dotted line) and data from low-density layers (represented by light dots above the middle dotted line). The low-density layers are filled with organic matter and reservoir fluids.

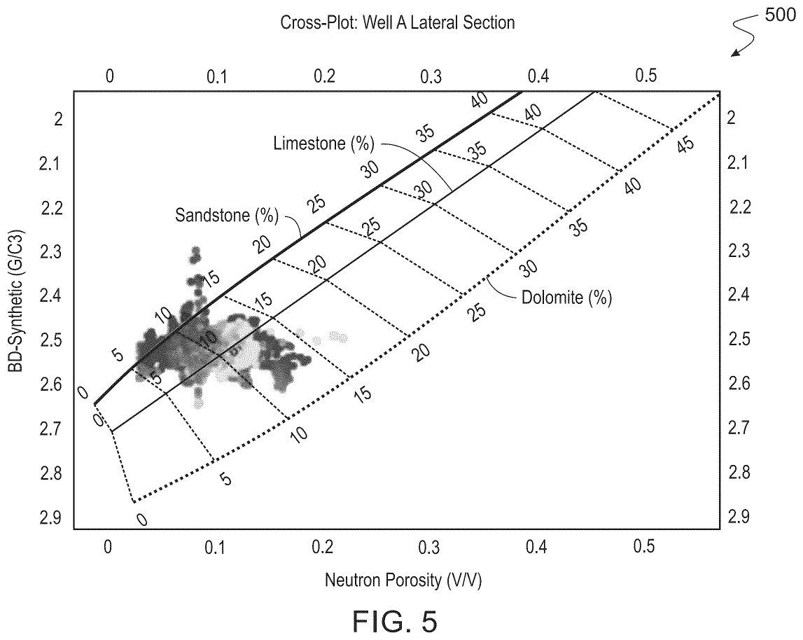

FIG. 5 shows another cross plot 500 of the predicted bulk density and neutron porosity from this first wellbore. The cross plot 500 shows the porosity falling between the limestone and dolomite lines, as confirmed by known formation lithology. The data points on the top left side are characterized by low density and high porosity, which correspond to the organic matter with lower clay content closer to the sandstone line.

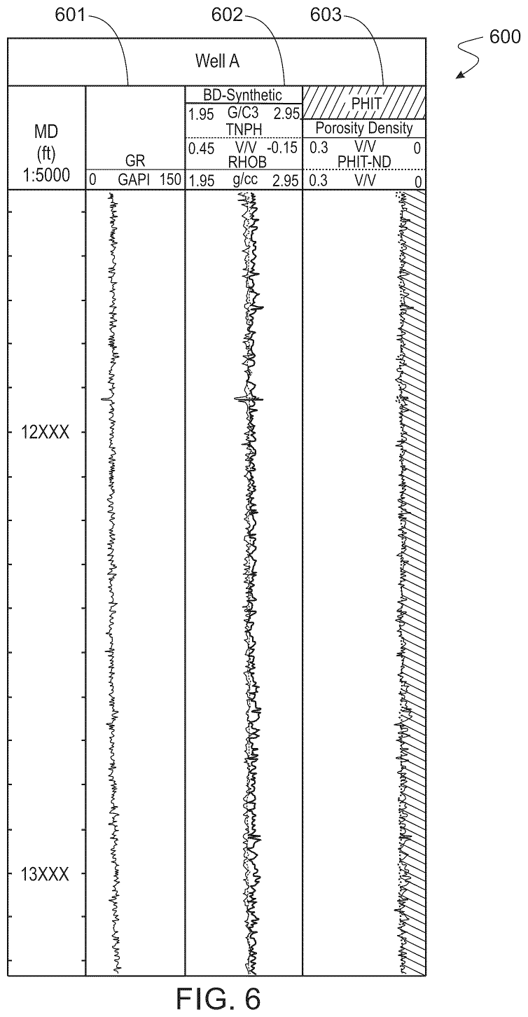

FIG. 6 shows chart 600 tabulating the calculated porosity using synthetic density log in the first well-bore. Track 601, like track 201 in FIG. 2, shows the average gamma ray measurements from the Up and Down quadrants over the same depth range. Track 602, similar to track 203 in FIG. 2, shows synthetic bulk density (BD) calculated based on equation 4, measured neutron porosity (TNPH), measured bulk density (RHOB), and as functions over the same depth range. Track 603 shows porosity determined based on neutron measurements (PHIT-ND) and predicted porosity (black) using synthetic density log across open hole interval. The predicted porosity does not factor in dense intervals where the porosity decreases slightly while cutting up the bed boundary. Based on the result, the derived density is capable of allowing an operator on-site to respond well to matrix and organic matter content within homogenous carbonate source rock.

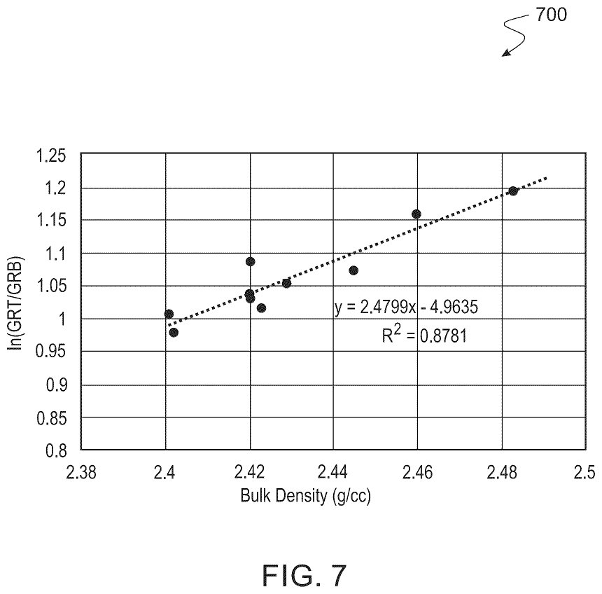

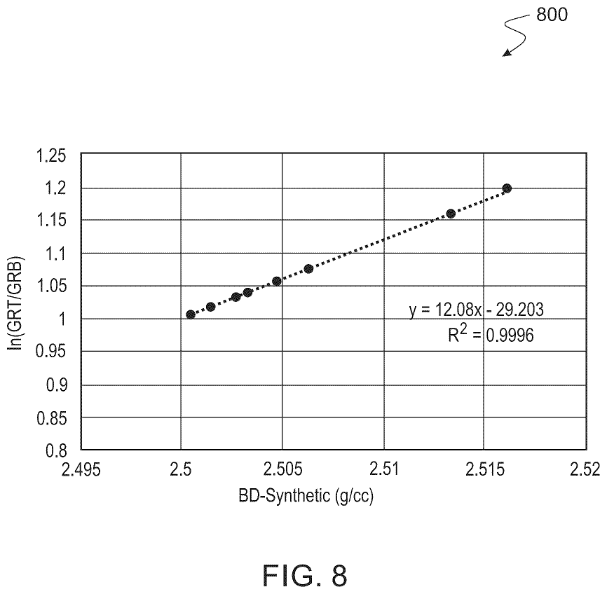

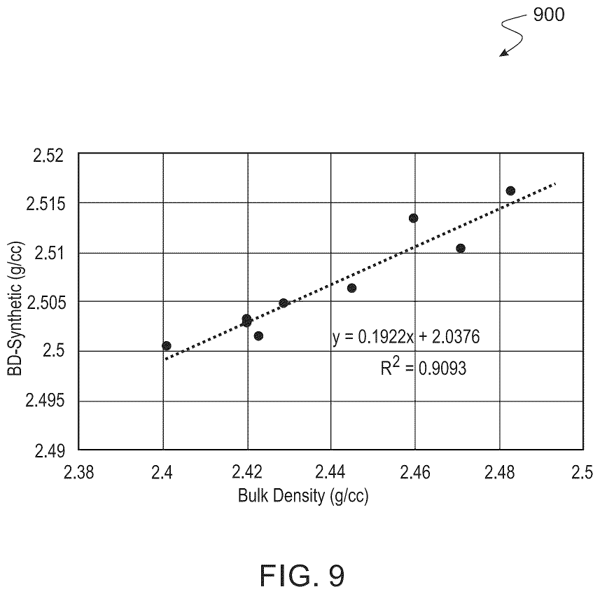

FIG. 7 shows a cross plot 700 of measured bulk density and the gamma ray ratio (from Up and Down quadrants), as used by some implementations, in the first wellbore. Using a least squares fit, cross plot 700 demonstrates a positive correlation between the measured bulk density and the gamma ratio with a chi square value of 0.8781. FIG. 8 shows a cross plot 800 of the synthetic bulk density and gamma ray ratio (from Up and Down quadrants), as used by some implementations, in the first wellbore. FIG. 9 shows a cross plot 900 of synthetic bulk density (obtained from equation 4) and measured bulk density (based on actual core sample analysis), demonstrating good agreement with a linear correlation and a chi square value of 0.9093.

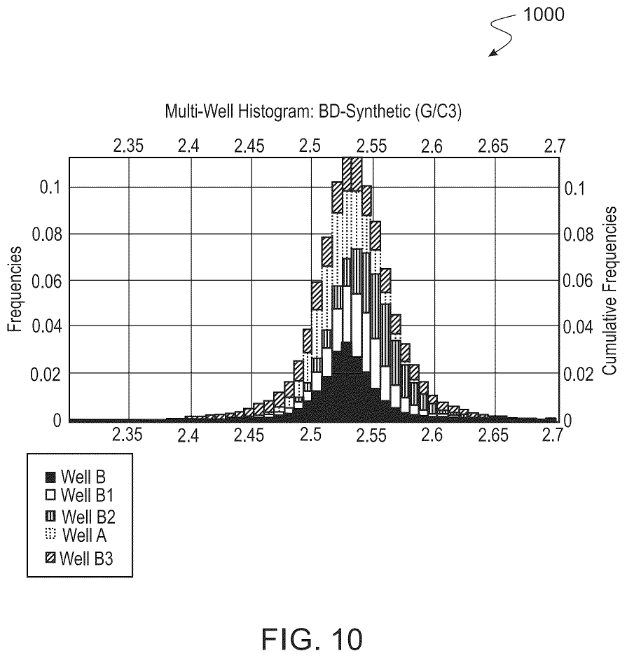

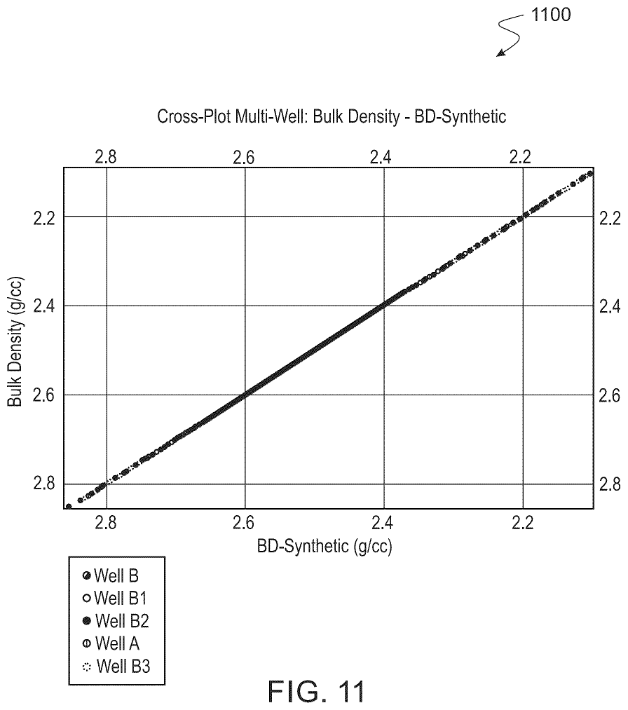

FIG. 10 shows a histogram 1000 of synthetic bulk density obtained from five wells. The number of instances for each value of bulk density have been normalized with respect to depth and filtered to cover the same formation intervals. FIG. 11 shows a cross plot 1100 of synthetic bulk density and measured bulk density, demonstrating near perfect match between measured formation density and predicted density log for this group of five wells drilled in same carbonate source rock reservoir.

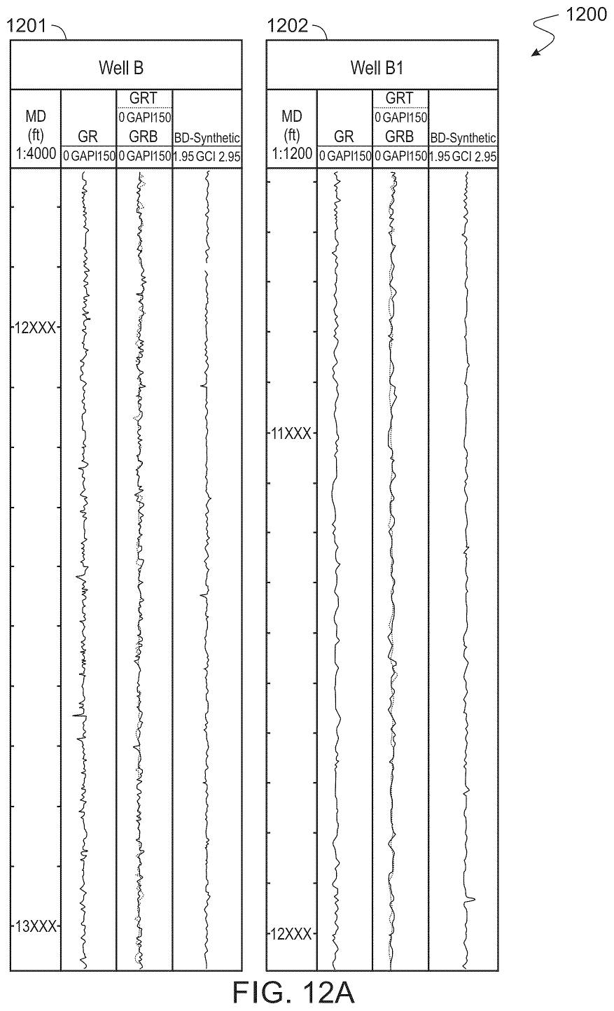

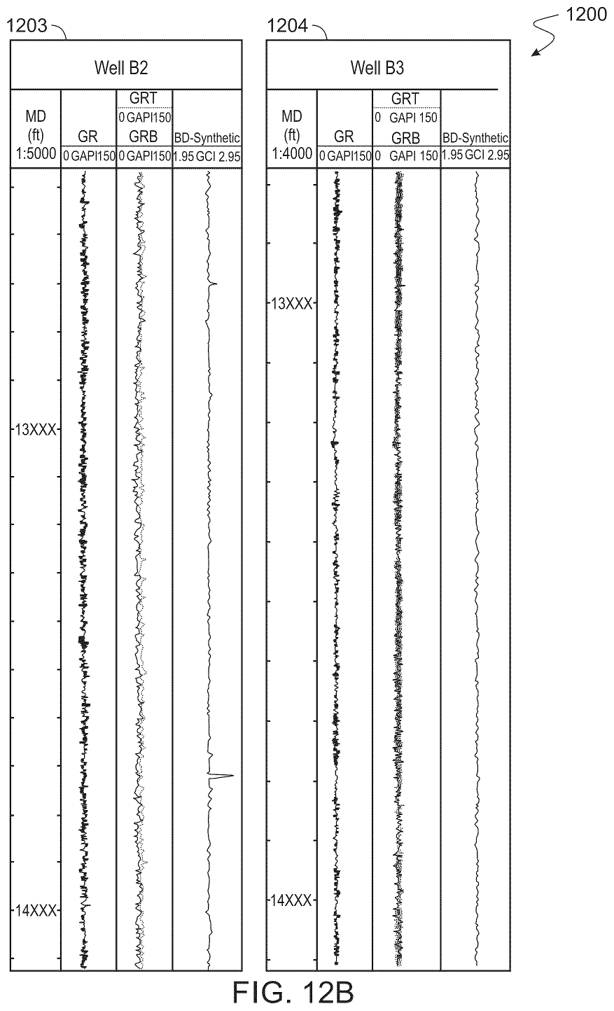

FIGS. 12A and 12B compare the measured bulk density (actual) and the synthetic bulk density (derived) for the second to the fifth wellbore in the same carbonate source rock reservoir. More specifically, panel 1201 shows, in the second wellbore (i.e., well B), the average gamma ray measurements from the Up and Down quadrants as a function of depth, the gamma ray measurements from the Up and Down quadrants (GRT and GRB) for the same depth range, and the synthetic/predicted bulk density for the same depth range. Panels 1202 to 1204 show the same data for the third (i.e., well B1), fourth (well B2), and fifth (well B3) wellbores respectively.

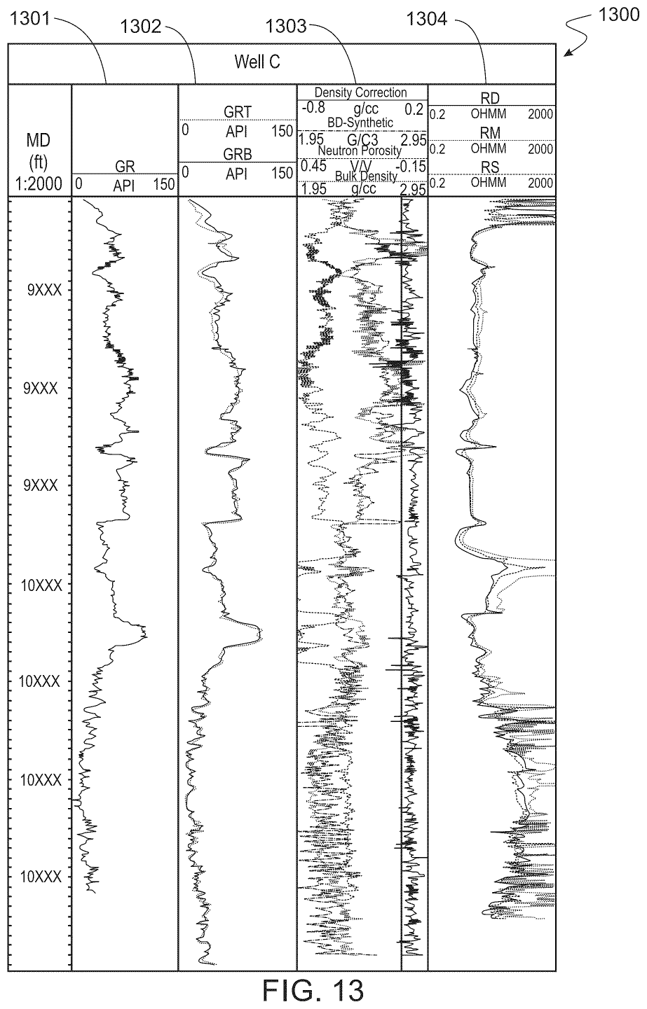

FIG. 13 shows a chart 1300 comparing synthetic bulk density and measured density in a sixth wellbore (i.e., well C). Track 1301 shows the average gamma ray measurements from the Up and Down quadrants as a function of depth. Track 1302 shows the gamma ray measurements from the Up and Down quadrants (GRT and GRB) over the same depth range. Track 1303 shows density correction, synthetic bulk density (BD) calculated based on equation 4, measured bulk density, and measured neutron porosity, as functions over the same depth range. As illustrated, the synthetic bulk density results are reasonable when compared to measured bulk density in clean sand. Accuracy reduction can be seen in the shale-sand zone due to local lithology variation, borehole conditions and fluid effect. Indeed, for clean or homogenous formation, the parameter C used in equation 4 is a constant. When the formation become more shally (e.g., containing shale) or includes more complex lithology, the parameter can be adjusted to calculate the density with less uncertainty. For example, some implementations can use cross plot to arrive at a compensating C. Because the type of the drilled formation or the environment is known, the formation bulk density can be estimated by, for example, assuming the pore fluid is 1 g/cc, clean sand is 2.65 g/cc, and pure limestone 2.71 g/cc as reference points for calibration, and then making adjustments based on the linear regression coefficient result. If clay minerals are added to the matrix, the formation bulk density may also change. Track 1304 shows resistivity as a function over the same depth range. The mnemonics RD, RM, RS respectively connate deep, medium and shallow induction resistivity curves. Induction LWD resistivity tool can provide resistivity measurement across the lateral section at different depths (for example, shallow, medium and deep) for investigation. The resistivity measurements combined with porosity can be used to calculate water saturation.

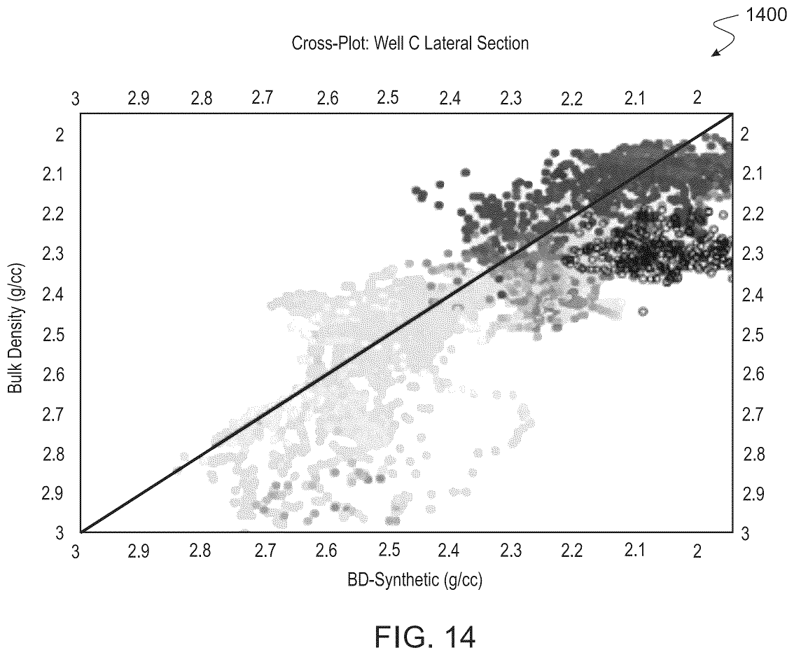

FIG. 14 shows cross plot 1400 comparing measured bulk density and derived density in the sixth wellbore (i.e., well C). Prior to the comparison, quality control was performed using density porosity cross plot for each rock type to reduce the discrepancy and improve the result. When quality control has removed outlier data, the synthetic bulk density can be obtained more efficiently and more accurately. The method can particularly distinguish between rock matrix within complex formation lithology. As illustrated in FIG. 14, the clean sand (towards the top right corner) is followed by interbedded limestone layers in the middle with shale interval (towards the left bottom).

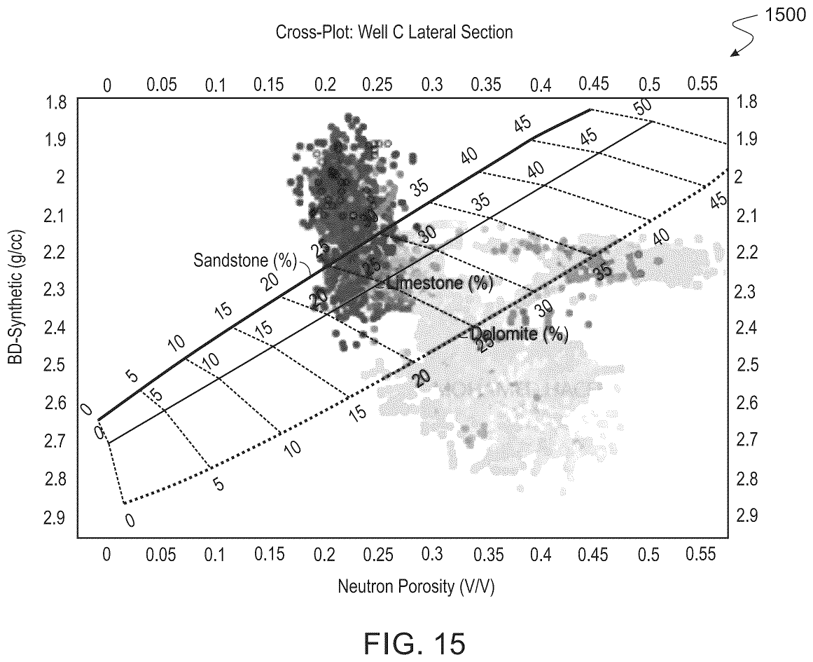

FIG. 15 shows cross plot 1500 comparing synthetic bulk density and measured neutron porosity. As illustrated, porosity data points corresponding to sandstone are clustered in the upper half with interbedded carbonates layers between the limestone and dolomite lines. The shale interval is located below the dolomites line. The gas data points are located on the top right above sandstone line. Moreover, shale and clay point are defined for shale classification.

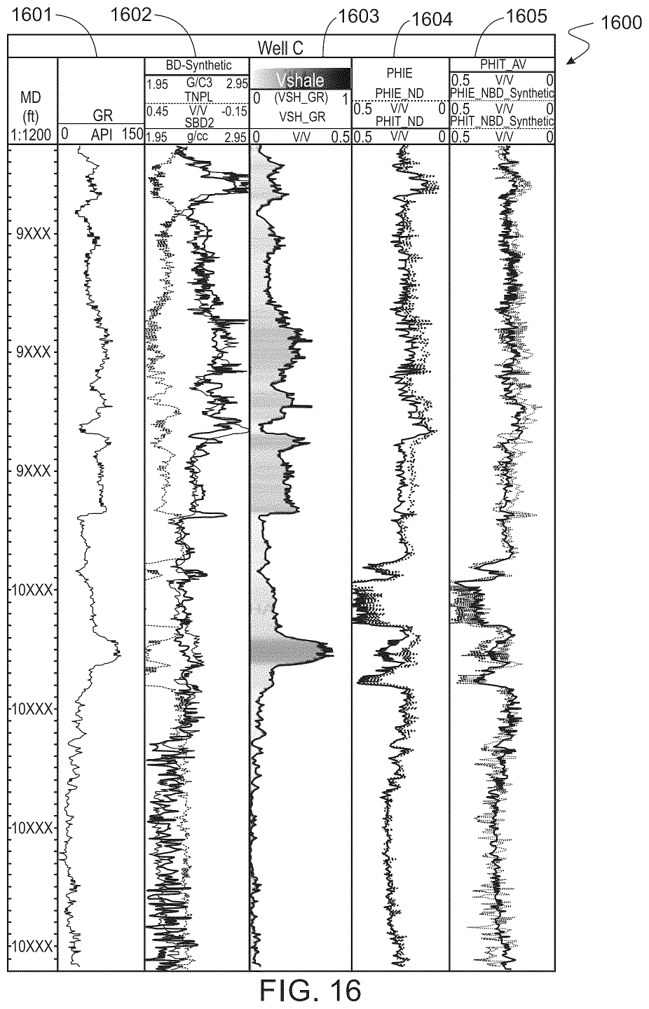

FIG. 16 shows chart 1600 demonstrating a significant agreement between the two calculated porosities (total and effective) across an open hole logged interval. Track 1601 shows the average gamma ray measurements from the Up and Down quadrants as a function of depth. Track 1602 shows the synthetic bulk density, and measured bulk density, and measured neutron porosity (TNPL) over the same depth range. Track 1603 shows the volume of shale (VSH) for depth locations over the same range. Track 1604 shows neutron measurements (PHIE and PHIT) for depth locations over the same range. Track 1605 shows the porosity (calculated from combining synthetic bulk density and neutron porosity) and the corrected density neutron porosity (calculated from using raw logs from logging tool). As shown, the two porosity curves are matched quite well. Here, the porosity calculated using derived density is not corrected for shale and gas effect because the density is derived from gamma alone. For example, the total porosity can be calculated using synthetic bulk density (including matrix density) for specific lithology (assuming fluid density is 1 g/cc), adding the apparent neutron porosity (measured by the nuclear tool), and applying an average of the two operands. This average provides the total porosity. In one example, the density matrix is 2.65 g/cc when dealing with sand formation. Porosity density can be calculated as following:

PHIT_NBD_Synthetic=RHOB−RHOM/RHOF−RHOM,

where PHIT_NBD_Synthetic is porosity density, RHOB=Synthetic bulk density, RHOM=density matrix (2.65 g/cc), and RHOF=Fluid Density (assumed to be 1 g/cc).

Next, TNPL is porosity neutron measured by the nuclear tool. For shale and gas effects, the corrected Total porosity is the average of the two total porosities (PHIT_NBD_Synthetic+TNPL)/2.

For the effective porosity as shown in Track 1605 calculated by using synthetic density:

PHIE_NBD_SYNTHETIC=PHIT_NBD_Synthetic−Vsh*(PHIT_Shale).

Here, the effective porosity can be computed as: Total porosity−(Vsh*PorosityShale), where Vsh is shale volume calculated using neutron measurements. As can be seen, the density-neutron porosity measurements are subject to correction due to gas/shale volume. By introducing the average porosity log (PHIT_AV), which compensates the effect of shale and gas, the effect of shale and gas on the neutron measurements and density estimates can be reduced.

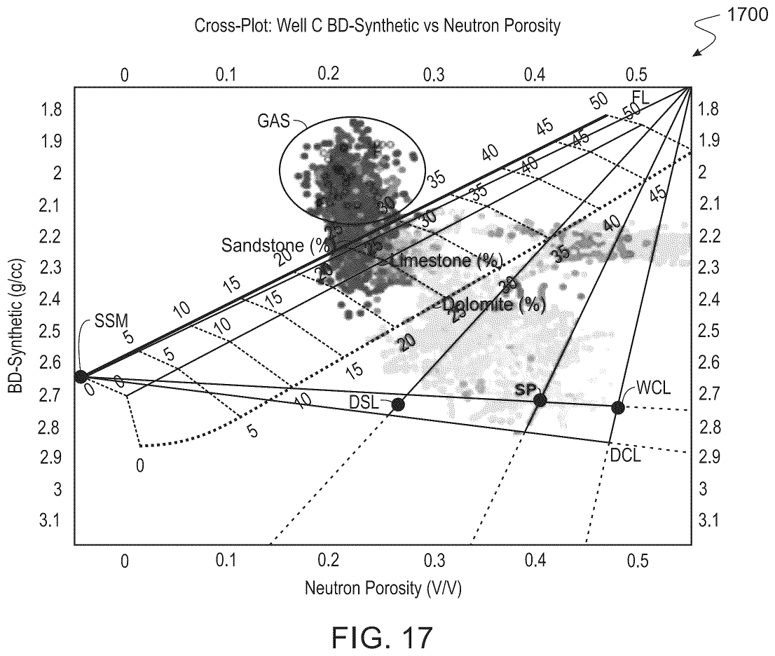

FIG. 17 shows cross plot 1700 comparing synthetic bulk density and neutron porosity for shale classification. The legends in cross plot 1700 include, SP: Shale point, DSL: Dry silt, WCL: Wet clay, DCL: Dry clay, SMM: Sandstone matrix, FL: Fluid. As illustrated, the shale points are clustered around the gas region, which is distinct from other regions. The derived bulk density has been integrated in the chart with neutron porosity for shale classification or clays typing. The obtained results confirm the accuracy of the synthetic density curve knowing that the gas can significantly affect the density. The synthetic curve can allow for identifying with accuracy the matrix density of SS and all shale point with gas zone on the top. The chart thus enables straightforward classification of the shale using accurate density and neutron porosity data and without using core or samples description.

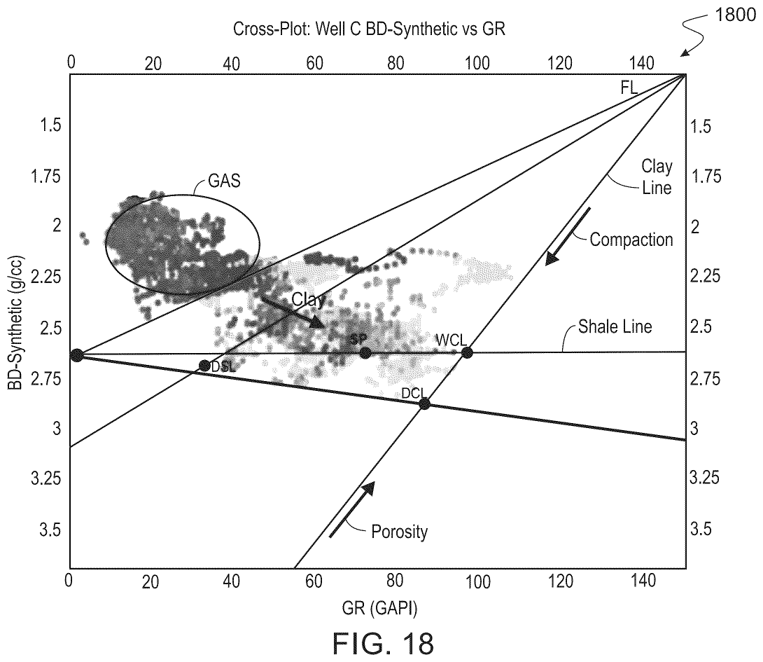

FIG. 18 shows cross plot 1800 comparing synthetic bulk density and gamma ray measurements. The legends are the same as FIG. 17. Combining gamma ray measurements with density estimates can thus identify the clay or shale deposition interval before fracking or perforating. This capability can save cost during well development by allowing an operator to select an interval with minimum water saturation (e.g., free, irreducible or bound water) without need to run NMR tool.

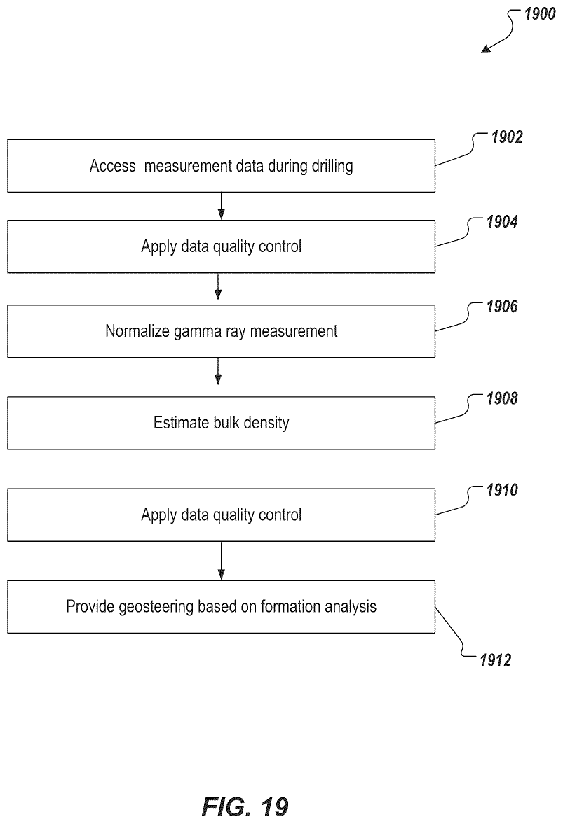

FIG. 19 is a flow chart 1900 illustrating an example of a process according to some implementations. The process may start with accessing data encoding measurements obtained from a bit tool during a drilling operation at a wellbore of a reservoir (1902). In particular, the measurements include gamma ray readings from, for example, gamma ray detector 100 a scintillator configuration mounted on the bit tool. The bit tool may additionally include a magnetometer configured to sense the Earth's magnetic field relative to the tool face while the bit tool rotates during a drilling operation. The sensed directional data can enable the counted rate from gamma detector 100 to be divided into several azimuthal sectors including, for example, four quadrants of Up, Right, Down, and Left, as described earlier in association with FIG. 1. The count rate in each sector can be obtained over a define acquisition time and converted to API units. The measurement data may also include flow rate, pressure, recorded neutron rate. Measured bulk density, for example, may be obtained from core samples extracted at various depth locations.

The process may then apply data quality control (1904). For example, outlier data can be removed from additional processing. The process may then normalize gamma ray measurements, for example, over a depth range for follow-on analysis (1906).

The process may then estimate the bulk density and compute the synthetic log (1908). In particular, when measured bulk density is not available because no core samples were taken, implementations may incorporate recorded gamma ray measurements to derive estimates of bulk density. For example, by applying equation 4, as described earlier, the implementations may derive an estimate of the bulk density based on gamma ray measurements from two distinct azimuthal positions at the same depth location. As revealed in equation 4, the two distinct azimuthal positions may correspond to two spatial quadrants. The implementations may proceed to synthesize a log of estimated bulk density within an entire depth range.

In some cases, the process may further apply quality control of the estimated bulk density and synthesized log (1910). As described earlier in association with, for example, FIGS. 4-5, 14-15, and 17-18, cross plots of the derived bulk density and measured density can be used as quality control to reduce discrepancy. For example, an offset parameter in the conversion used by equation 4 can be calibrated for each rock type based on the cross plot.

Some implementations may calculate a porosity for formation layers in the well-bore using the synthetic log of bulk density. As described earlier in association with, for example, FIG. 16, while a total porosity can be calculated using the synthetic log of bulk density, an effective porosity can be computed by correcting for shale volume in the formation layer. By introducing the average porosity log, which compensates the effect of shale and gas, the effect of shale and gas on the neutron measurements and density estimates can be reduced.

Based on the estimated bulk density and the porosity, the process may then proceed to conduct geosteering and reservoir characterization (1912). For example, in response to estimated bulk density and porosity, the process may assert intentional directional control of drilling inside the well 1 based on the results of downhole geological logging measurement so that the drilling can be kept inside, for example, in a particular section of a reservoir to potentially minimize gas or water breakthrough and maximize economic production from the well. In other examples, the process may conduct reservoir characterization of geomechanical parameters (e.g., rock mechanical properties), estimate of pore pressure, and identification of subsurface over-pressurized zone.

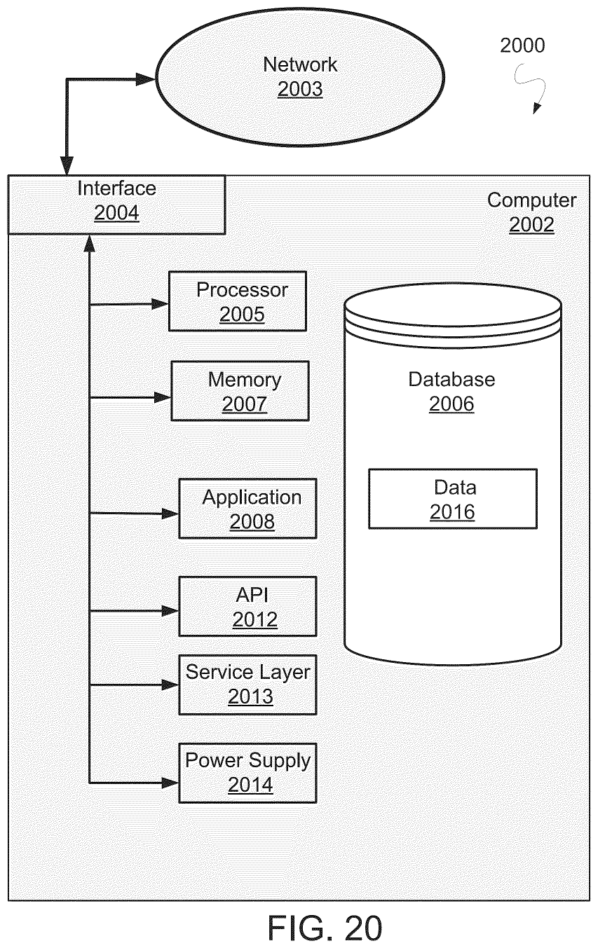

FIG. 20 is a block diagram illustrating an example of a computer system 2000 used to provide computational functionalities associated with described algorithms, methods, functions, processes, flows, and procedures, according to an implementation of the present disclosure. The illustrated computer 2002 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 2002 can comprise a computer that includes an input device, such as a keypad, keyboard, touch screen, another input device, or a combination of input devices that can accept user information, and an output device that conveys information associated with the operation of the computer 2002, including digital data, visual, audio, another type of information, or a combination of types of information, on a graphical-type user interface (UI) (or GUI) or other UI.

The computer 2002 can serve in a role in a computer system as a client, network component, a server, a database or another persistency, another role, or a combination of roles for performing the subject matter described in the present disclosure. The illustrated computer 2002 is communicably coupled with a network 2003. In some implementations, one or more components of the computer 2002 can be configured to operate within an environment, including cloud-computing-based, local, global, another environment, or a combination of environments.

The computer 2002 is an electronic computing device operable to receive, transmit, process, store, or manage data and information associated with the described subject matter. According to some implementations, the computer 2002 can also include or be communicably coupled with a server, including an application server, e-mail server, web server, caching server, streaming data server, another server, or a combination of servers.

The computer 2002 can receive requests over network 2003 (for example, from a client software application executing on another computer 2002) and respond to the received requests by processing the received requests using a software application or a combination of software applications. In addition, requests can also be sent to the computer 2002 from internal users, external or third-parties, or other entities, individuals, systems, or computers.

Each of the components of the computer 2002 can communicate using a system bus 2003. In some implementations, any or all of the components of the computer 2002, including hardware, software, or a combination of hardware and software, can interface over the system bus 2003 using an application programming interface (API) 2012, a service layer 2013, or a combination of the API 2012 and service layer 2013. The API 2012 can include specifications for routines, data structures, and object classes. The API 2012 can be either computer-language independent or dependent and refer to a complete interface, a single function, or even a set of APIs. The service layer 2013 provides software services to the computer 2002 or other components (whether illustrated or not) that are communicably coupled to the computer 2002. The functionality of the computer 2002 can be accessible for all service consumers using this service layer. Software services, such as those provided by the service layer 2013, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 2002, alternative implementations can illustrate the API 2012 or the service layer 2013 as stand-alone components in relation to other components of the computer 2002 or other components (whether illustrated or not) that are communicably coupled to the computer 2002. Moreover, any or all parts of the API 2012 or the service layer 2013 can be implemented as a child or a sub-module of another software module, enterprise application, or hardware module without departing from the scope of the present disclosure.

The computer 2002 includes an interface 2004. Although illustrated as a single interface 2004 in FIG. 20, two or more interfaces 2004 can be used according to particular needs, desires, or particular implementations of the computer 2002. The interface 2004 is used by the computer 2002 for communicating with another computing system (whether illustrated or not) that is communicatively linked to the network 2003 in a distributed environment. Generally, the interface 2004 is operable to communicate with the network 2003 and comprises logic encoded in software, hardware, or a combination of software and hardware. More specifically, the interface 2004 can comprise software supporting one or more communication protocols associated with communications such that the network 2003 or interface's hardware is operable to communicate physical signals within and outside of the illustrated computer 2002.

The computer 2002 includes a processor 2005. Although illustrated as a single processor 2005 in FIG. 20, two or more processors can be used according to particular needs, desires, or particular implementations of the computer 2002. Generally, the processor 2005 executes instructions and manipulates data to perform the operations of the computer 2002 and any algorithms, methods, functions, processes, flows, and procedures as described in the present disclosure.

The computer 2002 also includes a database 2006 that can hold data for the computer 2002, another component communicatively linked to the network 2003 (whether illustrated or not), or a combination of the computer 2002 and another component. For example, database 2006 can be an in-memory, conventional, or another type of database storing data consistent with the present disclosure. In some implementations, database 2006 can be a combination of two or more different database types (for example, a hybrid in-memory and conventional database) according to particular needs, desires, or particular implementations of the computer 2002 and the described functionality. Although illustrated as a single database 2006 in FIG. 20, two or more databases of similar or differing types can be used according to particular needs, desires, or particular implementations of the computer 2002 and the described functionality. While database 2006 is illustrated as an integral component of the computer 2002, in alternative implementations, database 2006 can be external to the computer 2002. As illustrated, the database 2006 holds the previously described data 2016 including, for example, data encoding the inference model, the solver, the prescribed defect patterns, simulated sensor data, and actual measurement data from the receivers.

The computer 2002 also includes a memory 2007 that can hold data for the computer 2002, another component or components communicatively linked to the network 2003 (whether illustrated or not), or a combination of the computer 2002 and another component. Memory 2007 can store any data consistent with the present disclosure. In some implementations, memory 2007 can be a combination of two or more different types of memory (for example, a combination of semiconductor and magnetic storage) according to particular needs, desires, or particular implementations of the computer 2002 and the described functionality. Although illustrated as a single memory 2007 in FIG. 20, two or more memories 2007 or similar or differing types can be used according to particular needs, desires, or particular implementations of the computer 2002 and the described functionality. While memory 2007 is illustrated as an integral component of the computer 2002, in alternative implementations, memory 2007 can be external to the computer 2002.

The application 2008 is an algorithmic software engine providing functionality according to particular needs, desires, or particular implementations of the computer 2002, particularly with respect to functionality described in the present disclosure. For example, application 2008 can serve as one or more components, modules, or applications. Further, although illustrated as a single application 2008, the application 2008 can be implemented as multiple applications 2008 on the computer 2002. In addition, although illustrated as integral to the computer 2002, in alternative implementations, the application 2008 can be external to the computer 2002.

The computer 2002 can also include a power supply 2014. The power supply 2014 can include a rechargeable or non-rechargeable battery that can be configured to be either user- or non-user-replaceable. In some implementations, the power supply 2014 can include power-conversion or management circuits (including recharging, standby, or another power management functionality). In some implementations, the power-supply 2014 can include a power plug to allow the computer 2002 to be plugged into a wall socket or another power source to, for example, power the computer 2002 or recharge a rechargeable battery.

There can be any number of computers 2002 associated with, or external to, a computer system containing computer 2002, each computer 2002 communicating over network 2003. Further, the term “client,” “user,” or other appropriate terminology can be used interchangeably, as appropriate, without departing from the scope of the present disclosure. Moreover, the present disclosure contemplates that many users can use one computer 2002, or that one user can use multiple computers 2002.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for conducting a measurement while drilling (MWD) operation in a wellbore of a reservoir, the method comprising:
accessing data encoding measurements obtained from a bit tool during the MWD operation in the wellbore of the reservoir, wherein the bit tool includes a gamma ray detector and a magnetometer;
extracting, from the measurements, recordings of the gamma ray detector, wherein the recordings comprise gamma ray measurements taken from more than one azimuthal sectors of a depth location in the wellbore;
estimating a bulk density at the depth location in the wellbore using the gamma ray measurements from the more than one azimuthal sectors; and
based on, at least in part, the estimated bulk density, causing an adjustment of the MWD operation.

2. The computer-implemented method of claim 1, further comprising:
extracting, from the measurements, recordings of the magnetometer; and
dividing the recordings of the gamma ray detectors into the more than one azimuthal sectors based on sensed directional data from magnetometer.

3. The computer-implemented method of claim 1, further comprising:
based on the estimated bulk density, synthesizing a bulk density log over a range of depth locations.

4. The computer-implemented method of claim 1, further comprising:
obtaining an estimated total porosity using the estimated bulk density at the depth location.

5. The computer-implemented method of claim 4, further comprising:
obtaining an estimated share of gas and shale at the depth location based on pulsed neutron measurements.

6. The computer-implemented method of claim 5, further comprising:
obtaining an estimated effective porosity that removes the estimated share of gas and shale from the estimated total porosity.

7. The computer-implemented method of claim 1, further comprising:
calibrating the estimated bulk density again bulk density measured at a core sample extracted from the wellbore at the depth location.

8. A computer system for conducting a measurement while drilling (MWD) operation in a wellbore of a reservoir, the computer system comprising one or more computer processors configured to perform operations of:
accessing data encoding measurements obtained from a bit tool during the MWD operation in the wellbore of the reservoir, wherein the bit tool includes a gamma ray detector and a magnetometer;
extracting, from the measurements, recordings of a gamma ray detector, wherein the recordings comprise gamma ray measurements taken from more than one azimuthal sectors of a depth location in the wellbore;
estimating a bulk density at the depth location in the wellbore using the gamma ray measurements from the more than one azimuthal sectors; and
based on, at least in part, the estimated bulk density, causing an adjustment of the MWD operation.

9. The computer system of claim 8, wherein the operations further comprise:
extracting, from the measurements, recordings of the magnetometer; and
dividing the recordings of the gamma ray detectors into the more than one azimuthal sectors based on sensed directional data from magnetometer.

10. The computer system of claim 8, wherein the operations further comprise:
based on the estimated bulk density, synthesizing a bulk density log over a range of depth locations.

11. The computer system of claim 8, wherein the operations further comprise:
obtaining an estimated total porosity using the estimated bulk density at the depth location.

12. The computer system of claim 11, wherein the operations further comprise:
obtaining an estimated share of gas and shale at the depth location based on pulsed neutron measurements.

13. The computer system of claim 12, wherein the operations further comprise:
obtaining an estimated effective porosity that subtracts the estimated share of gas and shale from the estimated total porosity.

14. The computer system of claim 8, wherein the operations further comprise:
calibrating the estimated bulk density again bulk density measured at a core sample extracted from the wellbore at the depth location.

15. A non-transitory computer-readable medium comprising software instructions for conducting a measurement while drilling (MWD) operation in a wellbore of a reservoir, which software instructions, when executed by a computer processor, cause the computer processor to perform operations of:
accessing data encoding measurements obtained from a bit tool during the MWD operation in the wellbore of the reservoir, wherein the bit tool includes a gamma ray detector and a magnetometer;
extracting, from the measurements, recordings of a gamma ray detector, wherein the recordings comprise gamma ray measurements taken from more than one azimuthal sectors of a depth location in the wellbore;
estimating a bulk density at the depth location in the wellbore using the gamma ray measurements from the more than one azimuthal sectors; and
based on, at least in part, the estimated bulk density, causing an adjustment of the MWD operation.

16. The non-transitory computer-readable medium of claim 15, wherein the operations further comprise:
extracting, from the measurements, recordings of the magnetometer; and
dividing the recordings of the gamma ray detectors into the more than one azimuthal sectors based on sensed directional data from magnetometer.

17. The non-transitory computer-readable medium of claim 15, wherein the operations further comprise:
based on the estimated bulk density, synthesizing a bulk density log over a range of depth locations.

18. The non-transitory computer-readable medium of claim 15, wherein the operations further comprise:
obtaining an estimated total porosity using the estimated bulk density at the depth location.

19. The non-transitory computer-readable medium of claim 18, wherein the operations further comprise:
obtaining an estimated share of gas and shale at the depth location based on pulsed neutron measurements; and
obtaining an estimated effective porosity that removes the estimated share of gas and shale from the estimated total porosity.

20. The non-transitory computer-readable medium of claim 15, wherein the operations further comprise:
calibrating the estimated bulk density again bulk density measured at a core sample extracted from the wellbore at the depth location.
